(19) United States
(12) Patent Application Publication
(10) Pub. No.: US 2025/0286306 A1
(43) Pub. Date: Sep. 11, 2025

(54) Bent Connector, Intermediate Connector, and Connector Assembly

(71) Applicant: Tyco Electronics AMP Korea Co., Ltd., Gyeongsan (KR)

(72) Inventors: Chang-Ho Lee, GYEONGSAN-SI (KR); Hyun Sang Park, Gyeongsan-Si (KR)

(73) Assignee: Tyco Electronics AMP Korea Co., Ltd., Gyeongsan (KR)

(21) Appl. No.: 19/070,643

(22) Filed: Mar. 5, 2025

(30) Foreign Application Priority Data
Mar. 5, 2024 (KR) 10-2024-0031510
Feb. 10, 2025 (KR) 10-2025-0016521

(51) Int. Cl. H01R 13/512; H01R 12/70; H01R 12/71; H01R 13/516; H01R 13/52; H01R 13/652

(52) U.S. Cl. CPC H01R 13/512; H01R 12/7088; H01R 12/718; H01R 13/516; H01R 13/5208; H01R 13/652

(57) ABSTRACT

A bent connector has an outer case including a case body, an inner insertion groove recessed in a first direction from a first side of the case body toward an inside of the case body, and a terminal insertion groove recessed in a second direction from a second side of the case body toward the inside of the case body. The bent connector has an inner housing inserted through the inner insertion groove, a wire assembly having at least a portion inserted into an inside of the inner housing, a terminal bus bar inserted through the terminal insertion groove and electrically connected to the wire assembly, and a fastening bolt physically and electrically fastening the terminal bus bar and the wire assembly to each other.

### CROSS-REFERENCE TO RELATED APPLICATION

This application claims the benefit of the filing date under 35 U.S.C. § 119(a)-(d) of Korean Patent Application No. 10-2024-0031510, filed on Mar. 5, 2024, and Korean Patent Application No. 10-2025-0016521, filed on Feb. 10, 2025.

### FIELD OF THE INVENTION

One or more embodiments relate to a bent connector, an intermediate connector, and a connector assembly.

### BACKGROUND OF THE INVENTION

A connector is a type of electrical component that may connect or disconnect electrical connections. The connector is used in various electronic and mechanical devices, such as automobiles or home appliances, to electrically and/or mechanically connect a plurality of electronic components.

Technologies are required to prevent damage to connection terminals by assisting in the arrangement of the connection terminals of the connector. In addition, technologies are required to manufacture the connector in a compact size.

The above description is information the inventor(s) acquired during the course of conceiving the present disclosure, or already possessed at the time, and is not necessarily art publicly known before the present application was filed.

### SUMMARY OF THE INVENTION

A bent connector has an outer case including a case body, an inner insertion groove recessed in a first direction from a first side of the case body toward an inside of the case body, and a terminal insertion groove recessed in a second direction from a second side of the case body toward the inside of the case body. The bent connector has an inner housing formed of an insulating material and inserted through the inner insertion groove from the first side of the case body, a wire assembly having at least a portion inserted into an inside of the inner housing in a direction in which the inner housing is inserted into the inner insertion groove, a terminal bus bar inserted through the terminal insertion groove from the second side of the case body and electrically connected to the wire assembly, and a fastening bolt inserted from the second side of the case body and mechanically and electrically fastening the terminal bus bar and the wire assembly to each other.

### BRIEF DESCRIPTION OF THE DRAWINGS

The invention will now be described by way of example with reference to the accompanying figures, of which:

FIG. 1 is a perspective view illustrating a connector assembly installed in an electronic device, according to an embodiment;

FIG. 2 is a perspective view illustrating a bent connector and an intermediate connector that are separated from the electronic device, according to an embodiment;

FIG. 3 is an exploded cross-sectional view of the connector assembly according to an embodiment;

FIG. 4 is a cross-sectional view illustrating a portion of the bent connector exploded, according to an embodiment;

FIG. 5 is a perspective view illustrating a coupling relationship between a terminal housing and a terminal bus bar, according to an embodiment;

FIG. 6 is a cross-sectional view and a partially enlarged view of FIG. 5;

FIG. 7 is a perspective view of the intermediate connector according to an embodiment;

FIG. 8 is a cross-sectional view of the intermediate connector according to an embodiment; and

FIG. 9 is a perspective view illustrating a portion of a bent connector according to an embodiment.

### DETAILED DESCRIPTION

Hereinafter, embodiments are described in detail with reference to the accompanying drawings. However, various alterations and modifications may be made to the embodiments and thus, the scope of the disclosure is not limited or restricted to the embodiments. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

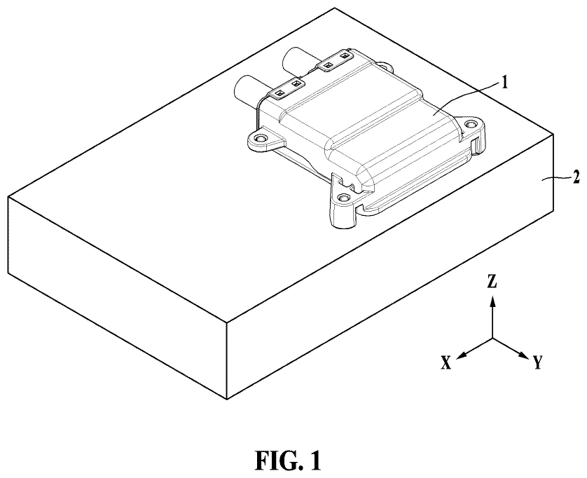

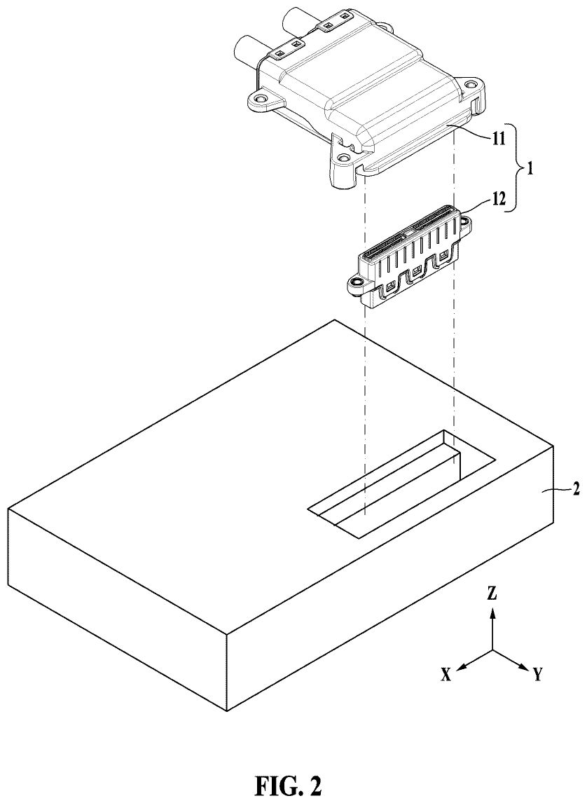

Referring to FIGS. 1 to 4, a connector assembly 1 according to an embodiment may be connected to an electronic device 2 (e.g., a power supply, a battery module, and/or an inverter) provided inside a vehicle, for example, to transmit power from the electronic device 2 to the outside or from the outside to the electronic device 2. Here, the electronic device 2 may include a device case 21 and a device bus bar 23 electrically connected to an internal component of the device case 21. For example, the device bus bar 23 may be accommodated inside an intermediate groove 22 formed to be recessed from an outer surface of the device case 21, but embodiments are not limited thereto.

According to an embodiment, the connector assembly 1 may be designed such that a height protruding from an outer surface of the electronic device 2 is low, thereby reducing overall volume. In this structure, the space that the electronic device 2 may occupy in the vehicle may be increased. For example, a width direction (e.g., a +/−x-axis direction) of the connector assembly 1 may be parallel to an outer surface (e.g., an upper surface (a surface perpendicular to a +z-axis) and/or a front surface (a surface perpendicular to a +y-axis) with respect to FIG. 1) of the electronic device 2 with which the connector assembly 1 is in contact. For example, the connector assembly 1 may include a bent connector 11 and an intermediate connector 12.

According to an embodiment, the bent connector 11 may be installed on the outer surface of the electronic device 2. For example, the bent connector 11 may receive power from a conductive member (e.g., the device bus bar 23) formed in a vertical direction (e.g., a +z-axis direction) from the inside of the electronic device 2 and may bend transmission direction of the power to transmit the power in a direction parallel to the outer surface (e.g., the upper surface with respect to FIG. 1) of the electronic device 2. For example, the bent connector 11 may include an outer case 111, an inner housing 112, a fastening nut 113, a wire assembly 114, a terminal support housing 115, a terminal bus bar 116, and a fastening bolt 117.

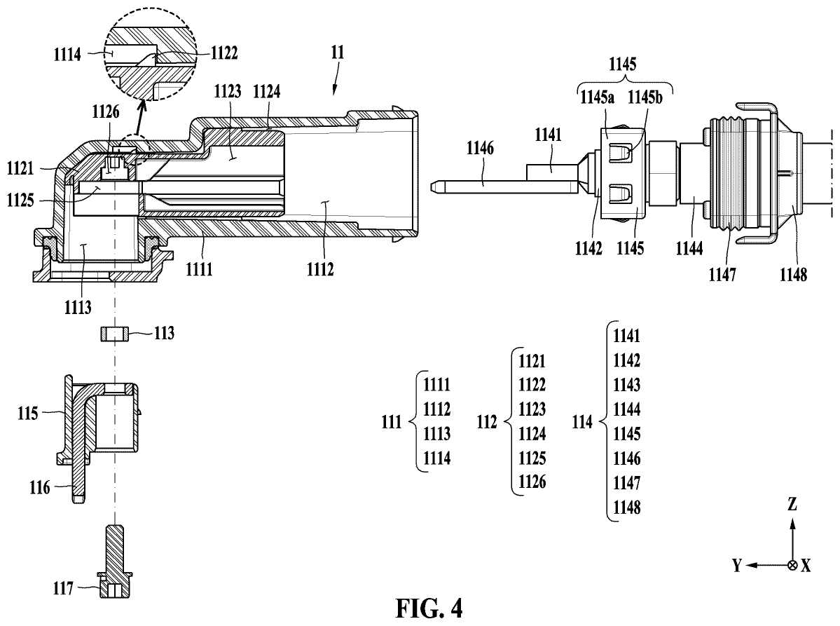

According to an embodiment, as shown in FIG. 4, the outer case 111 may include a case body 1111, an inner insertion groove 1112 that is formed to be recessed in a direction (e.g., a +y-axis direction) from one side (e.g., an end side in a −y-axis direction) of the case body 1111 toward the inside of the case body 1111, a terminal insertion groove 1113 that is formed to be recessed in a direction (e.g., the +z-axis direction) from the other side (e.g., an end side in a −z-axis direction) of the case body 1111 toward the inside of the case body 1111 in a direction (e.g., a +/−z-axis direction) intersecting with a direction (e.g., the +y-axis direction) in which the inner insertion groove 1112 is recessed, and an outer-side inner locking structure 1114 in which at least a portion of the inner housing 112 may be caught.

According to an embodiment, the case body 1111 may be formed of a conductive material. With this configuration, a ground line may be formed to transmit current leaking from the wire assembly 114 to the outside through a grounding ferrule 1145 of the wire assembly 114 and the case body 1111. Therefore, it may be possible to reduce issues of causing operational errors in electronic components, such as leakage current acting as noise on electronic components inside the vehicle.

According to an embodiment, the inner insertion groove 1112 and the terminal insertion groove 1113 may communicate with each other. In a portion where the inner insertion groove 1112 and the terminal insertion groove 1113 communicate with each other, the wire assembly 114 and the terminal bus bar 116 may be connected to each other.

According to an embodiment, the outer-side inner locking structure 1114 may be formed to be recessed on an inner wall of the case body 1111. In this structure, a portion (e.g., an inner-side outer locking structure 1122) of the inner housing 112 is caught by the outer-side inner locking structure 1114, as shown in FIG. 4, inhibiting the inner housing 112 from being separated from the outer case 111. In another example, the inner-side outer locking structure 1122 may be caught in a corner area that is in contact with the inner insertion groove 1112, in the terminal insertion groove 1113. In this case, it may be understood that the above-described corner area is the outer-side inner locking structure 1114. In this structure, since there is no need to form a separate groove on the inner wall of the case body 1111, manufacturing cost of the case body 1111 may be reduced.

According to an embodiment, the inner housing 112 may be inserted through the inner insertion groove 1112 from one side (e.g., the end side in the −y-axis direction) of the case body 1111. For example, the inner housing 112 may include an inner body 1121, the inner-side outer locking structure 1122, a wire insertion groove 1123, a ferrule insertion groove 1124, a plate insertion groove 1125, and a nut groove 1126.

According to an embodiment, the inner body 1121 may be formed of an insulating material (e.g., resin) to reduce power from being directly transmitted from a conductive wire 1141 or a conductive plate 1146 of the wire assembly 114 to the outer case 111. For example, at least a portion of the inner body 1121 may be positioned at a portion where the inner insertion groove 1112 and the terminal insertion groove 1113 meet each other.

According to an embodiment, the inner-side outer locking structure 1122 may have a shape that protrudes outwardly (e.g., in the +z-axis direction) from the inner housing 112 as the inner-side outer locking structure 1122 extends in a direction (e.g., the −y-axis direction) where the inner housing 112 is separated from the inner insertion groove 1112. In this structure, when the inner housing 112 is inserted into the inner insertion groove 1112 by a predetermined length or more, the inner-side outer locking structure 1122 is caught on an inner wall (e.g., the inner-side outer locking structure 1122) of the outer case 111, thereby inhibiting the inner housing 112 from being separated from the inner insertion groove 1112.

According to an embodiment, the wire insertion groove 1123 may be formed to be recessed in a direction (e.g., the +y-axis direction) in which the inner insertion groove 1112 is recessed from one side (right side of FIG. 4) of the inner body 1121. For example, the wire assembly 114 may be inserted into the wire insertion groove 1123. For example, between the inner insertion groove 1112 and the inner wall of the case body 1111, there may be a structure in which the inner insertion groove 1112 and the inner wall of the case body 1111 are surrounded by the inner body 1121, thereby reducing direct contact between the conductive wire 1141 or the conductive plate 1146 of the wire assembly 114 and the inner wall of the case body 1111.

According to an embodiment, the ferrule insertion groove 1124 may be formed to be recessed stepwise from an outer surface of the inner body 1121. In this structure, at least a portion of the grounding ferrule 1145 of the wire assembly 114 may be inserted into a space between the inner wall of the case body 1111 and the ferrule insertion groove 1124. For example, an inner surface of the grounding ferrule 1145 may be supported by an outer surface of the ferrule insertion groove 1124, thereby increasing a contact force between the grounding ferrule 1145 and the inner wall of the case body 1111.

According to an embodiment, the plate insertion groove 1125 may be formed to be further recessed in a direction in which the inner insertion groove 1112 is recessed from the wire insertion groove 1123. For example, the conductive plate 1146 of the wire assembly 114 may be inserted into the plate insertion groove 1125. For example, at least a portion of an inner wall of the plate insertion groove 1125 may support one surface of the conductive plate 1146, thereby reducing an issue of the conductive plate 1146 being pushed out during a bolting process using the fastening bolt 117 and allowing the conductive plate 1146 and the terminal bus bar 116 to be stably bolted together.

According to an embodiment, the nut groove 1126 may be formed to be recessed in a direction (e.g., the +z-axis direction) in which the fastening bolt 117 is inserted from the plate insertion groove 1125 into the case body 1111. For example, the fastening nut 113 and the nut groove 1126 may have polygonal shapes (e.g., square shapes) that are complementary to each other. According to such a shape, an issue of the fastening nut 113 idling with respect to the nut groove 1126 during the bolting process may be reduced, and thus, a bolting operation may be stably performed. However, it should be noted that the shape of the fastening nut 113 is not limited thereto.

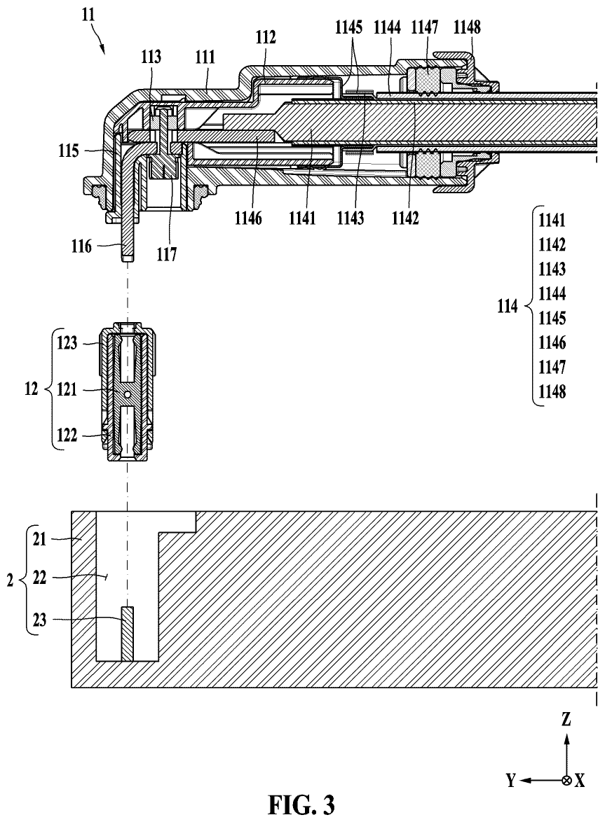

According to an embodiment, as shown in FIGS. 3 and 4, the fastening nut 113 may be arranged on the opposite side of the terminal bus bar 116 with respect to the conductive plate 1146 of the wire assembly 114 and may be fastened to the fastening bolt 117. In this structure, the conductive plate 1146 and the terminal bus bar 116 may be arranged to be in close contact with each other by bolting the fastening nut 113 and the fastening bolt 117 to each other. For example, the fastening nut 113 may be formed of a material (e.g., metal) that is stronger than the inner housing 112. In this structure, compared to the case where the fastening bolt 117 is directly fastened to the inner housing 112 without the fastening nut 113, fastening rigidity may be improved and an issue of damage to a screw groove may be reduced, thereby helping to improve a lifespan of an entire product.

Furthermore, the fastening nut 113 according to an embodiment may be fixed to the conductive plate 1146, as shown in FIG. 3. For example, the fastening nut 113 may be fixed to a hole formed in the conductive plate 1146 in a press fit and/or welding method, but embodiments are not limited thereto.

According to an embodiment, the wire assembly 114 may be inserted from one side (e.g., an end side in the −y-axis direction) of the outer case 111. For example, the wire assembly 114 may be inserted along a direction (e.g., the +y-axis direction) in which the inner housing 112 is inserted into the inner insertion groove 1112. For example, at least a portion of the wire assembly 114 may be inserted into the inside of the inner housing 112. For example, the wire assembly 114 may include the conductive wire 1141 formed of a conductive material and inserted along the wire insertion groove 1123, an inner insulation layer 1142 wrapping the conductive wire 1141, an outer insulation layer 1144 wrapping the inner insulation layer 1142, a shield layer 1143 at least partly positioned between the inner insulation layer 1142 and the outer insulation layer 1144, the grounding ferrule 1145, the conductive plate 1146, a wire seal 1147 for reducing foreign substances from entering the inner insertion groove 1112 from the outside, and a wire-side cover 1148 for covering the inner insertion groove 1112.

According to an embodiment, the shield layer 1143 is formed of a conductive material and may transmit current leaking from the conductive wire 1141 to the outside (e.g., the case body 1111) of the wire assembly 114. For example, the shield layer 1143 may have a mesh shape but is not limited thereto. For example, at least a portion of the shield layer 1143 may be positioned between the inner insulation layer 1142 and the outer insulation layer 1144. For example, as shown in FIG. 3, the remaining portion of the shield layer 1143 may be in surface contact with the grounding ferrule 1145. In this structure, the shield layer 1143 may transmit current leaking from the conductive wire 1141 to the grounding ferrule 1145.

According to an embodiment, one side of the grounding ferrule 1145 may be in contact with the shield layer 1143, and the other side of the grounding ferrule 1145 may be in contact with the case body 1111. For example, the grounding ferrule 1145 may include a ferrule body 1145a and a contact portion 1145b that is formed to protrude from the ferrule body 1145a toward the inner wall of the case body 1111 and is elastically deformable, as shown in FIG. 4.

According to an embodiment, the conductive plate 1146 may be connected to an end of the conductive wire 1141 and may be inserted along the plate insertion groove 1125. For example, a width direction (e.g., the +/−x-axis direction) of the conductive plate 1146 may be parallel to a width direction (e.g., the +/−x-axis direction) of the outer case 111. For example, a normal direction (e.g., the +/−z-axis direction) to a surface of the conductive plate 1146 may be parallel to a direction (e.g., the +z-axis direction) in which the terminal insertion groove 1113 is formed to be recessed. In this structure, in the case where a surface shape of the conductive plate 1146 is arranged in a direction (e.g., the +/−z-axis direction) perpendicular to the outer surface (e.g., an upper surface (the surface perpendicular to the +z-axis) with respect to FIG. 3) of the electronic device 2, the height of an entire shape of the conductive plate 1146 and the bent connector 11 including the conductive plate 1146 protruding from the outer surface (e.g., the upper surface with respect to FIG. 3) of the electronic device 2 may be reduced. For example, the width direction (e.g., the +/−x-axis direction) of the conductive plate 1146 and a width direction (e.g., the +/−x-axis direction) of the terminal bus bar 116 may each be parallel to a width direction (e.g., the +/−x-axis direction) of the outer case 111.

According to an embodiment, the terminal support housing 115 may be inserted through the terminal insertion groove 1113 from the other side (e.g., a lower side of FIG. 3) of the case body 1111 and formed of an insulating material (e.g., resin). However, it should be noted that, unlike the drawing, the terminal support housing 115 may be omitted. An example of the terminal support housing 115 is described below.

According to an embodiment, the terminal bus bar 116 may be electrically connected to the wire assembly 114. For example, the terminal bus bar 116 may be inserted from the other side (e.g., the end side in the −z-axis direction) of the outer case 111. For example, the terminal bus bar 116 may be inserted through the terminal insertion groove 1113 from the other side of the case body 1111 and electrically connected to the wire assembly 114. For example, a width direction (e.g., the +/−x-axis direction) of the terminal bus bar 116 may be parallel to the outer surface (e.g., the upper surface (the surface perpendicular to the +z-axis) and/or the front surface (the surface perpendicular to the +y-axis) with respect to FIG. 1) of the electronic device 2. In this structure, compared to a case where a surface shape of the terminal bus bar 116 is arranged in a direction (e.g., a +/−y-axis direction) perpendicular to the outer surface (e.g., a left surface (a surface perpendicular to the +y-axis) with respect to FIG. 3) of the electronic device 2, the height of an entire shape of the terminal bus bar 116 and the bent connector 11 including the terminal bus bar 116 protruding from the outer surface (e.g., the left surface with respect to FIG. 3) of the electronic device 2 may be reduced. For example, the width direction (e.g., the +/−x-axis direction) of the terminal bus bar 116 may be parallel to the width direction (e.g., the +/−x-axis direction) of the outer case 111. For example, an end of the terminal bus bar 116 may have a bent shape with respect to a longitudinal direction (e.g., the +/−y-axis direction) of the wire assembly 114. For example, one end of the terminal bus bar 116 may be connected to the conductive plate 1146, and the other end of the terminal bus bar 116 may be extended in a bent shape in a direction (e.g., the +/−z-axis direction) perpendicular to the longitudinal direction (e.g., the +/−y-axis direction) of the wire assembly 114. An example of the terminal bus bar 116 is described below.

According to an embodiment, the fastening bolt 117 may be inserted from the other side (e.g., a lower side of FIG. 3) of the outer case 111 (e.g., the case body 1111) to mechanically and electrically fasten the terminal bus bar 116 and the wire assembly 114 (e.g., the conductive plate 1146) to each other. For example, the fastening bolt 117 may be fastened to the fastening nut 113 and/or the inner body 1121 by penetrating the terminal bus bar 116 and the conductive plate 1146.

According to an embodiment, the intermediate connector 12 may mechanically and electrically connect the electronic device 2 (e.g., the device bus bar 23) and the bent connector 11 (e.g., the terminal bus bar 116) to each other. For example, the intermediate connector 12 may include a bidirectional terminal 121, a device-side intermediate housing 122, and a connector-side intermediate housing 123.

According to an embodiment, as shown in FIG. 3, each end of the bidirectional terminal 121 may be connected to a pair of bus bars (e.g., the device bus bar 23 and the terminal bus bar 116). In this configuration, in a process of installing the bent connector 11 in the electronic device 2, separate wiring work may be omitted or reduced, and thus, the time and effort required for an assembly process may be reduced, thereby improving work convenience of a worker. For example, the bidirectional terminal 121 may be formed in a thin plate shape, and a plurality of the bidirectional terminals 121 may be arranged along the width direction (e.g., the +/−x-axis direction) of the terminal bus bar 116. In this configuration, the number of the bidirectional terminals 121 may be adjusted according to the width of the terminal bus bar 116 or the size of power transmitted through the terminal bus bar 116. Examples of configurations of other intermediate connectors 12 are described below.

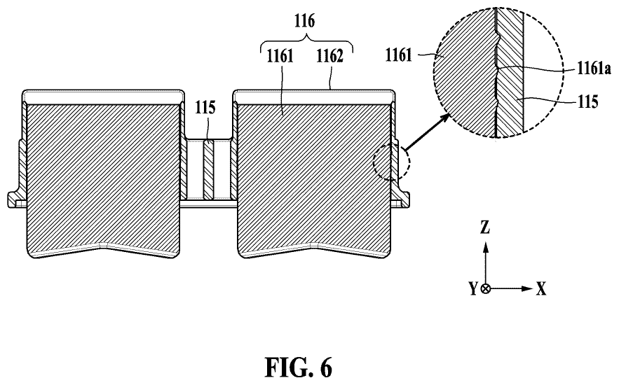

Referring to FIGS. 4, 5, and 6, the terminal bus bar 116 according to an embodiment may include a vertical portion 1161 and a horizontal portion 1162.

According to an embodiment, the vertical portion 1161 may extend parallel to a longitudinal direction (e.g., the +/−z-axis direction) of the terminal insertion groove 1113. For example, the vertical portion 1161 may have a shape parallel to the outer surface (e.g., the left surface with respect to FIG. 3) of the electronic device 2. For example, a normal direction (e.g., the +/−y-axis direction) to a surface of the vertical portion 1161 may be parallel to a direction (e.g., the +/−y-axis direction) in which the inner insertion groove 1112 is formed to be recessed. According to an embodiment, the vertical portion 1161 may include at least one fixing protrusion 1161a that is formed to protrude in a direction perpendicular to a longitudinal direction (e.g., the +/−z-axis direction) of the vertical portion 1161. The fixing protrusion 1161a according to an embodiment may be interference-fitted into an inner wall of a bus bar insertion hole 1152 of the terminal support housing 115. In this structure, a fastening force between the terminal support housing 115 and the terminal bus bar 116 may be improved, and thus, an issue of the terminal bus bar 116 being separated from the terminal support housing 115 or being inappropriately arranged may be reduced during the assembly process.

According to an embodiment, the horizontal portion 1162 may have a bent shape from the vertical portion 1161, may extend parallel to a longitudinal direction (e.g., the +/−y-axis direction) of the inner insertion groove 1112, and may be in surface contact with the conductive plate 1146. For example, the horizontal portion 1162 may have a shape that is parallel to the outer surface (e.g., the upper surface with respect to FIG. 3) of the electronic device 2.

According to an embodiment, the terminal support housing 115 may include a support housing body 1151 having a shape corresponding to the terminal insertion groove 1113, the bus bar insertion hole 1152 into which the vertical portion 1161 is inserted, a bus bar mounting groove 1153 into which the horizontal portion 1162 is mounted, a bolting hole 1154 communicating with the bus bar mounting groove 1153 and through which the fastening bolt 117 may pass, and a terminal-side outer locking structure 1155 on which at least a portion of the inner housing 112 may be caught.

According to an embodiment, the bus bar insertion hole 1152 may be formed to penetrate the support housing body 1151. For example, the bus bar insertion hole 1152 may be formed in a shape corresponding to the vertical portion 1161 so that the vertical portion 1161 may be stably accommodated inside the bus bar insertion hole 1152. For example, the bus bar insertion hole 1152 may be formed of a material having lower rigidity than the fixing protrusion 1161a, and thus, the fixing protrusion 1161a may be interference-fitted into an inner wall of the bus bar insertion hole 1152.

According to an embodiment, the bus bar mounting groove 1153 may have a stepwise shape from one surface of the support housing body 1151. For example, the bus bar mounting groove 1153 may have a shape communicating with the bus bar insertion hole 1152. For example, a partition wall may be provided on at least a portion or all of a circumference of the bus bar mounting groove 1153 so that the horizontal portion 1162 may be stably accommodated in the bus bar mounting groove 1153.

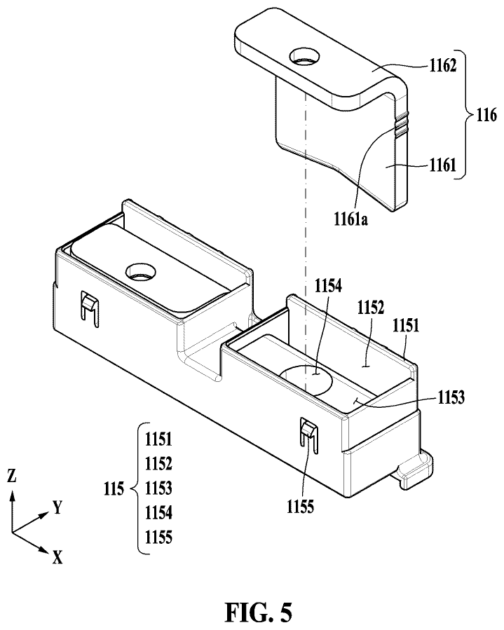

According to an embodiment, as shown in FIG. 5, the terminal-side outer locking structure 1155 may have a shape that protrudes outwardly (e.g., in the −y-axis direction) from the support housing body 1151 as the terminal-side outer locking structure 1155 extends in a direction (e.g., the −z-axis direction) where the terminal support housing 115 is separated from the terminal insertion groove 1113. In this structure, when the terminal support housing 115 is inserted into the terminal insertion groove 1113 by a predetermined length or more, the terminal-side outer locking structure 1155 is caught on the inner wall of the outer case 111, thereby inhibiting the terminal support housing 115 from being separated from the terminal insertion groove 1113.

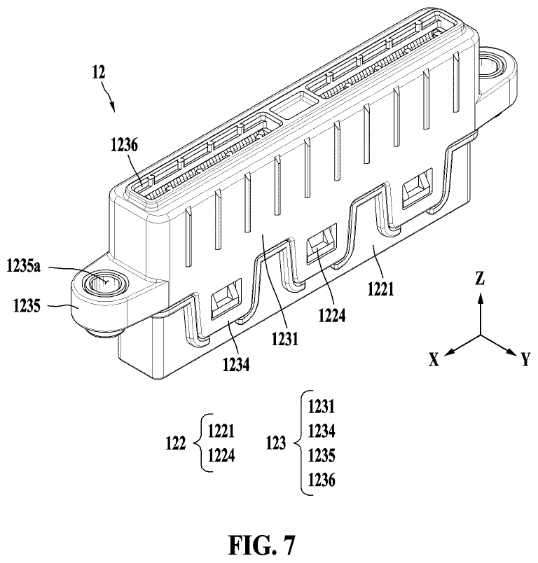

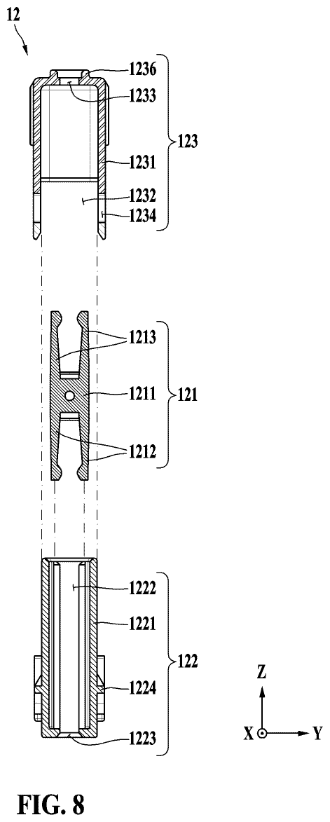

Referring to FIGS. 7 and 8, the intermediate connector 12 according to an embodiment may include the bidirectional terminal 121, the device-side intermediate housing 122, and the connector-side intermediate housing 123.

According to an embodiment, the bidirectional terminal 121 may include, for example, a terminal body 1211, a device-side connection portion 1212 extending in one direction (e.g., the −z-axis direction) from the terminal body 1211 and elastically contactable on both sides of the device bus bar 23, and a connector-side connection portion 1213 extending in the other direction (e.g., the +z-axis direction) from the terminal body 1211 and elastically contactable on both sides of the terminal bus bar 116.

According to an embodiment, the device-side connection portion 1212 may include a pair of legs, and each end of the pair of legs may be formed to protrude inwardly, thereby being in contact with the device bus bar 23. For example, a portion of the pair of legs excluding the end may have a smaller cross-sectional area than the end. In this shape, when the device bus bar 23 is inserted between the pair of legs, the pair of legs may be easily and elastically deformed to insert the device bus bar 23 smoothly, and in a state where the device bus bar 23 is inserted, each end of the pair of legs may be in close contact with the device bus bar 23 by an elastic restoring force of the pair of legs.

According to an embodiment, the connector-side connection portion 1213 may include a pair of legs, and each end of the pair of legs may be formed to protrude inwardly, thereby being in contact with the terminal bus bar 116. For example, unless otherwise stated, the description of the device-side connection portion 1212 may be equally applied to the connector-side connection portion 1213, and a detailed description thereof is omitted.

According to an embodiment, the device-side intermediate housing 122 may include a first intermediate housing body 1221, an accommodation space 1222 in which the bidirectional terminal 121 is accommodated, a device-side connection slot 1223 that communicates with the accommodation space 1222 and through which the device bus bar 23 may pass, and a first locking structure 1224 that is caught on the connector-side intermediate housing 123.

According to an embodiment, the first intermediate housing body 1221 may be formed of an insulating material (e.g., resin) to reduce power from being directly transmitted from the bidirectional terminal 121 or the device bus bar 23 to an inner wall of the intermediate groove 22 of the electronic device 2.

According to an embodiment, the accommodation space 1222 may be formed to be recessed from an outer surface (e.g., an upper surface of FIG. 8) of the first intermediate housing body 1221 in which an opening into which the bidirectional terminal 121 is inserted is positioned. For example, the accommodation space 1222 may have a width formed in a direction (e.g., the +/−x-axis direction) parallel to the outer surface (e.g., the left surface with respect to FIG. 3) of the electronic device 2. In this shape, the number of the bidirectional terminals 121 to be accommodated in the accommodation space 1222 may be adjusted according to a width of the device bus bar 23 or the size of power flowing through the device bus bar 23. For example, the bidirectional terminal 121 may be prevented from being separated to the outside by a bottom wall of the accommodation space 1222.

According to an embodiment, as shown in FIG. 8, the device-side connection slot 1223 may be formed to penetrate the bottom wall of the accommodation space 1222 and communicate with the accommodation space 1222. For example, the device-side connection slot 1223 may be formed to have a size and a shape that allow the device bus bar 23 to pass through and prevent the bidirectional terminal 121 from being separated.

According to an embodiment, as shown in FIG. 8, the first locking structure 1224 may be formed to protrude outwardly from the first intermediate housing body 1221 as the first locking structure 1224 extends in a direction (e.g., the −z-axis direction) where the first intermediate housing body 1221 moves away from the second intermediate housing body 1231. The first locking structure 1224 may reduce the connector-side intermediate housing 123 from being separated from the device-side intermediate housing 122.

According to an embodiment, the connector-side intermediate housing 123 may include the second intermediate housing body 1231, an insertion space 1232 in which the device-side intermediate housing 122 is inserted, a connector-side connection slot 1233 that communicates with the insertion space 1232 and through which the terminal bus bar 116 may pass, a second locking structure 1234 that is caught on the device-side intermediate housing 122, a device fastening structure 1235, and an insulating guide 1236.

According to an embodiment, the second intermediate housing body 1231 may be formed of an insulating material (e.g., resin) to reduce power from being directly transmitted from the bidirectional terminal 121 or the terminal bus bar 116 to the inner wall of the intermediate groove 22 of the electronic device 2.

According to an embodiment, the insertion space 1232 may be formed to be recessed from an outer surface (e.g., a lower surface of FIG. 8) of the second intermediate housing body 1231 in which an opening into which the bidirectional terminal 121 is inserted is positioned. For example, the insertion space 1232 may have a width formed in a direction (e.g., the +/−x-axis direction) parallel to the outer surface (e.g., the left surface with respect to FIG. 3) of the electronic device 2. For example, the insertion space 1232 may have a cross-sectional shape corresponding to a circumference of the first intermediate housing body 1221. In this structure, the intermediate connector 12 may be assembled by inserting the device-side intermediate housing 122 into the insertion space 1232 in a state where the bidirectional terminal 121 is inserted into the device-side intermediate housing 122.

According to an embodiment, the connector-side connection slot 1233 may be formed to penetrate a bottom wall of the insertion space 1232 and communicate with the insertion space 1232. For example, the connector-side connection slot 1233 may be formed to have a size and a shape that allow the terminal bus bar 116 to pass through and prevent the bidirectional terminal 121 from being separated.

According to an embodiment, the second locking structure 1234 may be coupled to the first locking structure 1224 when the first intermediate housing body 1221 is inserted into the second intermediate housing body 1231 by a predetermined distance or more. For example, the second locking structure 1234 may have a groove or hole shape into which the first locking structure 1224 may be inserted. For example, the second locking structure 1234 may have a shape that extends in a direction (e.g., the −z-axis direction) away from the connector-side connection slot 1233 in a cantilever shape from the second intermediate housing body 1231. For example, the second locking structure 1234 may be elastically deformed outwardly from the second intermediate housing body 1231. In this structure, in a process of inserting the device-side intermediate housing 122 into the connector-side intermediate housing 123, the second locking structure 1234 may be opened outward and may pass through the first locking structure 1224, and in a state where the device-side intermediate housing 122 is inserted into the connector-side intermediate housing 123 by a predetermined length or more, the second locking structure 1234 may be deformed to an original shape by an elastic restoring force and may be caught by the first locking structure 1224.

According to an embodiment, the device fastening structure 1235 may be formed to protrude outwardly from the second intermediate housing body 1231 in a direction (e.g., the +/−z-axis direction) perpendicular to a direction (e.g., the +z-axis direction) in which the first intermediate housing body 1221 is inserted into the second intermediate housing body 1231, as shown in FIG. 7. For example, in the device fastening structure 1235, a fastening hole (1235a) may be formed through which a fastening structure may pass, wherein the fastening structure is fixable to the device case 21 by being inserted in a direction (e.g., the −z-axis direction) opposite to a direction in which the first intermediate housing body 1221 is inserted into the second intermediate housing body 1231.

According to an embodiment, the insulating guide 1236 may have a shape that surrounds the connector-side connection slot 1233 and may be formed to extend from the second intermediate housing body 1231 toward the bent connector 11. For example, one side of the terminal support housing 115 may be inserted into an inner side of the insulating guide 1236. The terminal bus bar 116 may be connected to the connector-side connection portion 1213 by passing through the insulating guide 1236 and the connector-side connection slot 1233 sequentially.

However, when the distance between adjacent conductive structures is reduced below a predetermined distance, there may be a risk of spark discharge. The distance between two conductive structures causing spark discharge represented as the shortest distance along a surface of a solid dielectric is referred to as a creeping distance. According to the insulating guide 1236 described above, by increasing the creeping distance, electrical stability of the entire connector assembly 1 and the electronic device 2 may be improved.

For example, in a state where the bidirectional terminal 121, the device-side intermediate housing 122, and the connector-side intermediate housing 123 are connected to each other, the intermediate connector 12 may have a shape that surrounds the remaining portion except for the device-side connection slot 1223 and the connector-side connection slot 1233 formed in a longitudinal direction of the bidirectional terminal 121. For example, the remaining portion of the bidirectional terminal 121 except for the device-side connection slot 1223 and the connector-side connection slot 1233 may not be exposed to the outside. For example, a circumferential direction of the bidirectional terminal 121 may not be exposed to the outside of the intermediate connector 12 by the device-side intermediate housing 122 and/or the connector-side intermediate housing 123. For example, the device-side connection slot 1223 may be formed only on one surface of the first intermediate housing body 1221 and may not be formed on the remaining surface of the first intermediate housing body 1221. For example, the connector-side connection slot 1233 may be formed only on one surface of the second intermediate housing body 1231 and may not be formed on the remaining surface of the second intermediate housing body 1231. In such a shape, the intermediate connector 12 may allow insertion of the device bus bar 23 and the terminal bus bar 116 and may reduce a portion of an internal structure of the intermediate connector 12 exposed to the outside, thereby reducing an issue of foreign substances entering the inside of the intermediate connector 12 from the outside.

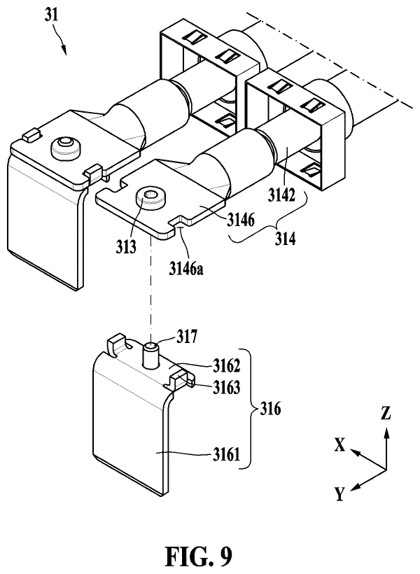

Referring to FIG. 9, a bent connector 31 (e.g., the bent connector 11 of FIG. 3) according to an embodiment may include an outer case (e.g., the outer case 111 of FIG. 3), an inner housing (e.g., the inner housing 112 of FIG. 3), a fastening nut 313 (e.g., the fastening nut 113 of FIG. 3), a wire assembly 314 (e.g., the wire assembly 114 of FIG. 3), a terminal support housing (e.g., the terminal support housing 115 of FIG. 3), a terminal bus bar 316 (e.g., the terminal bus bar 116 of FIG. 3), and a fastening bolt 317 (e.g., the fastening bolt 117 of FIG. 3).

FIG. 9 illustrates a coupling relationship between the terminal bus bar 316 and the wire assembly 314. For example, according to the structure illustrated in FIG. 9, the terminal support housing 115 as shown in FIG. 3 may be omitted, but embodiments are not limited thereto.

According to an embodiment, the wire assembly 314 may include a conductive wire (e.g., the conductive wire 1141 of FIG. 3), an inner insulation layer (3142) (e.g., the inner insulation layer 1142 of FIG. 3), an outer insulation layer (e.g., the outer insulation layer 1144 of FIG. 3), a shield layer (e.g., the shield layer 1143 of FIG. 3), a grounding ferrule (e.g., the grounding ferrule 1145 of FIG. 3), a conductive plate 3146 (e.g., the conductive plate 1146 of FIG. 3), a wire seal (e.g., the wire seal 1147 of FIG. 3), and a wire-side cover (e.g., the wire-side cover 1148 of FIG. 3). According to an embodiment, the conductive plate 3146 may include a guide groove 3146a. According to an embodiment, the guide groove 3146a may have a shape recessed from at least one side surface of both side surfaces of the conductive plate 3146, but embodiments are not limited thereto.

According to an embodiment, the fastening nut 313 may be fixed to the conductive plate 3146. For example, the fastening nut 313 may be fixed to a hole formed in the conductive plate 3146 in a press fit and/or welding method, but embodiments are not limited thereto.

According to an embodiment, the terminal bus bar 316 may include a vertical portion 3161 (e.g., the vertical portion 1161 of FIG. 5), a horizontal portion 3162 (e.g., the horizontal portion 1162 of FIG. 5), and a guide protrusion 3163. According to an embodiment, the guide protrusion 3163 may have a shape that is cut and bent from a portion of the horizontal portion 3162. For example, the guide protrusion 3163 may be inserted into the guide groove 3146a so that the terminal bus bar 316 may be properly arranged with the conductive plate 3146. In this arranged state, by fastening the fastening bolt 317 to the fastening nut 313, the conductive plate 3146 and the horizontal portion 3162 may be mechanically and electrically coupled to each other.

As described above, although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and/or equivalents of the claims are within the scope of the following claims.

1. A bent connector, comprising:
an outer case including a case body, an inner insertion groove recessed in a first direction from a first side of the case body toward an inside of the case body, and a terminal insertion groove recessed in a second direction from a second side of the case body toward the inside of the case body, the second direction intersecting with the first direction;
an inner housing formed of an insulating material and inserted through the inner insertion groove from the first side of the case body;
a wire assembly having at least a portion inserted into an inside of the inner housing in a direction in which the inner housing is inserted into the inner insertion groove;
a terminal bus bar inserted through the terminal insertion groove from the second side of the case body and electrically connected to the wire assembly; and
a fastening bolt inserted from the second side of the case body and mechanically and electrically fastening the terminal bus bar and the wire assembly to each other.

2. The bent connector of claim 1, wherein
the inner insertion groove and the terminal insertion groove communicate with each other;
the inner housing includes:
an inner body having at least a portion located where the inner insertion groove and the terminal insertion groove meet each other;
a wire insertion groove recessed in the first direction; and
a plate insertion groove formed to be further recessed in the first direction from the wire insertion groove, and
the wire assembly includes:
a conductive wire formed of a conductive material and inserted along the wire insertion groove; and
a conductive plate connected to an end of the conductive wire and inserted and supported along the plate insertion groove.

3. The bent connector of claim 2, wherein the wire assembly includes:
an inner insulation layer wrapping the conductive wire;
an outer insulation layer wrapping the inner insulation layer;
a shield layer having at least a portion of the shield layer located between the inner insulation layer and the outer insulation layer and configured to transmit current leaking from the conductive wire to an outside; and
a grounding ferrule having a first side in contact with the shield layer and a second side in contact with the case body.

4. The bent connector of claim 3, wherein the grounding ferrule has a contact portion that is formed to protrude toward an inner wall of the case body and is elastically deformable.

5. The bent connector of claim 3, wherein the inner housing has a ferrule insertion groove recessed stepwise from an outer surface of the inner body, and at least a portion of the grounding ferrule is inserted into a space between an inner wall of the case body and the ferrule insertion groove.

6. The bent connector of claim 2, further comprising a fastening nut arranged on an opposite side of the terminal bus bar with respect to the conductive plate, the fastening nut is fastened to the fastening bolt.

7. The bent connector of claim 6, wherein the inner housing has a nut groove recessed in a direction in which the fastening bolt is inserted into the case body from the plate insertion groove, the fastening nut and the nut groove have polygonal shapes that are complementary to each other.

8. The bent connector of claim 2, wherein the terminal bus bar includes:
a vertical portion extending parallel to a longitudinal direction of the terminal insertion groove; and
a horizontal portion having a bent shape from the vertical portion, extending parallel to a longitudinal direction of the inner insertion groove, and being in surface contact with the conductive plate.

9. The bent connector of claim 8, wherein a normal direction to a surface of the conductive plate is parallel to the second direction, and a normal direction to a surface of the vertical portion is parallel to the first direction.

10. The bent connector of claim 8, further comprising a terminal support housing inserted through the terminal insertion groove from the second side of the case body and formed of an insulating material, the terminal support housing has a bus bar insertion hole into which the vertical portion is inserted and a bus bar mounting groove in which the horizontal portion is mounted.

11. The bent connector of claim 10, wherein the terminal support housing has a bolting hole that is connected to the bus bar mounting groove and through which the fastening bolt passes.

12. The bent connector of claim 2, wherein a width direction of the conductive plate and a width direction of the terminal bus bar are each parallel to a width direction of the outer case.

13. The bent connector of claim 1, wherein the inner housing has an inner-side outer locking structure having a shape that protrudes outwardly from the inner housing, and when the inner housing is inserted into the inner insertion groove by at least a predetermined length, the inner-side outer locking structure is caught on an inner wall of the outer case, inhibiting separation of the inner housing from the inner insertion groove.

14. An intermediate connector configured to connect an electronic device having a device case and a device bus bar electrically connected to an internal component of the device case to a bent connector including a wire assembly and a terminal bus bar that is electrically connected to the wire assembly and has an end portion in a bent shape with respect to a longitudinal direction of the wire assembly, the intermediate connector comprising:
a bidirectional terminal including a terminal body, a device-side connection portion extending in a first direction from the terminal body and elastically contacting a pair of sides of the device bus bar, and a connector-side connection portion extending in a second direction from the terminal body and elastically contacting a pair of sides of the terminal bus bar;
a device-side intermediate housing including a first intermediate housing body, an accommodation space in which the bidirectional terminal is accommodated, and a device-side connection slot that communicates with the accommodation space and through which the device bus bar passes; and
a connector-side intermediate housing including a second intermediate housing body, an insertion space in which the device-side intermediate housing is inserted, and a connector-side connection slot that communicates with the insertion space and through which the terminal bus bar passes.

15. The intermediate connector of claim 14, wherein the connector-side intermediate housing includes a device fastening structure that protrudes outwardly from the second intermediate housing body in a direction perpendicular to a direction in which the first intermediate housing body is inserted into the second intermediate housing body, and in the device fastening structure, a fastening hole is formed through which a fastening structure passes, the fastening structure is fixable to the device case by being inserted in a direction opposite to the direction in which the first intermediate housing body is inserted into the second intermediate housing body.

16. The intermediate connector of claim 14, wherein the device-side intermediate housing has a first locking structure that protrudes outwardly, and the connector-side intermediate housing has a second locking structure coupled to the first locking structure when the first intermediate housing body is inserted into the second intermediate housing body by at least a predetermined distance, the second locking structure is elastically deformable in an outward direction of the second intermediate housing body.

17. A connector assembly, comprising:
a bent connector including an outer case, a wire assembly inserted from a first side of the outer case, a terminal bus bar inserted from a second side of the outer case, and a fastening bolt inserted from the second side of the outer case and mechanically and electrically fastening the terminal bus bar and the wire assembly to each other; and
an intermediate connector installable in an electronic device having a device case and a device bus bar electrically connected to an internal component of the device case, the intermediate connector mechanically and electrically connects the device bus bar to the terminal bus bar.

18. The connector assembly of claim 17, wherein the intermediate connector includes:
a bidirectional terminal including a terminal body, a device-side connection portion extending in a first direction from the terminal body and elastically contacting a pair of sides of the device bus bar, and a connector-side connection portion extending in a second direction from the terminal body and elastically contacting a pair of sides of the terminal bus bar;
a device-side intermediate housing including a first intermediate housing body, an accommodation space in which the bidirectional terminal is accommodated, and a device-side connection slot that communicates with the accommodation space and through which the device bus bar passes; and
a connector-side intermediate housing including a second intermediate housing body, an insertion space in which the device-side intermediate housing is inserted, and a connector-side connection slot that communicates with the insertion space and through which the terminal bus bar passes.

19. The connector assembly of claim 17, wherein a width direction of the terminal bus bar is parallel to a width direction of the outer case.

20. The connector assembly of claim 18, wherein the connector-side intermediate housing has an insulating guide having a shape that surrounds the connector-side connection slot and extending from the second intermediate housing body toward the bent connector.
